(19) United States
(12) Patent Application Publication
(10) Pub. No.: US 2011/0108142 A1
(43) Pub. Date: May 12, 2011

(54) VAPOR CHAMBER AND MANUFACTURING METHOD THEREOF

(76) Inventors: Juei-Khai Liu, Taipei City (TW); Chao-Tsai Chung, Taipei City (TW)

(21) Appl. No.: 12/900,480

(22) Filed: Oct. 8, 2010

(30) Foreign Application Priority Data
Nov. 10, 2009 (TW) 098138150

(51) Int. Cl. F03B 11/02; B23P 11/00

(52) U.S. Cl. 137/561 R; 29/428

(57) ABSTRACT

This invention discloses a vapor chamber and a manufacturing method thereof. The vapor chamber includes a casing, a working fluid, a waterproof layer, and a wick structure layer. The working fluid is filled into the casing. The waterproof layer is formed on inner walls of the casing. The wick structure layer is formed on the waterproof layer.

### CROSS-REFERENCE TO RELATED APPLICATIONS

This Non-provisional application claims priority under 35 U.S.C. §119(a) on Patent Application No(s). 098138150 filed in Taiwan, Republic of China on Nov. 10, 2009, the entire contents of which are hereby incorporated by reference.

### BACKGROUND OF THE INVENTION

1. Field of the Invention

This invention relates to heat dissipation and, more particularly, to a vapor chamber using water as a working fluid and having a better heat dissipation effect and a manufacturing method thereof.

2. Description of the Related Art

In recent years, as a size of an electronic device is developed to be light, slim, short, and small, heat dissipation of the electronic device is gradually paid more attention to. In a plurality of heat dissipating devices, since a vapor chamber also called flat plate heat pipe has excellent transverse and longitudinal heat conduction characteristics, the vapor chamber is widely used as a heat dissipating device of an electronic device, such as a central processing unit, a graphic processing unit, a high power transistor, a high power light-emitting diode and so on, thereby ensuring that the electronic device can work in a normal state and can avoid a breakdown caused by overheating.

Generally speaking, since aluminum has a plurality of advantages such as having light weight, low cost and so on, a conventional vapor chamber mostly uses an aluminum alloy as a main material. Particularly, in aerospace industry, the aluminum vapor chamber is mostly used as one element of a thermal management system. FIG. 1A is an exploded diagram showing a conventional aluminum vapor chamber.

In FIG. 1A, a vapor chamber 1 includes a body 10, a first side plate 12, a second side plate 14, and a filling pipe 16. A filling hole 120 is disposed at the first side plate 12, and a groove 100 is disposed at the body 10. The vapor chamber 1 uses the groove 100 (or an aluminum mesh, a stainless steel mesh) as a wick structure, and a working fluid (such as acetone, CFCs, or liquid ammonia and so on) which is chemically compatible with aluminum and is incapable of reacting with the aluminum is filled into the vapor chamber 1 via the filling pipe 16.

FIG. 1B is a sectional diagram showing a conventional aluminum vapor chamber. In FIG. 1B, the contacting area becomes a heating area when a heat source contacts the lower part of the vapor chamber 1. A liquid working fluid F_{c} absorbs heat Qᵢₙ of the heat source at the heating area and evaporates into a gaseous working fluid Fₕ thus to diffuse to other areas in the interior of the vapor chamber 1. When the gaseous working fluid Fₕ contacts a cooling area at the upper part of the vapor chamber 1, the gaseous working fluid Fₕ releases the stored latent heat and condenses into the liquid working fluid F_{c}, and heat Qₒᵤₜ is dissipated to the outside of the vapor chamber 1 from the cooling area. Further, the liquid working fluid F_{c} is guided to the heating area via capillary force provided by the wick structure such as the groove 100 to complete one cycle. Therefore, the conventional aluminum vapor chamber 1 can achieve a heat dissipation effect via a phase change between a liquid phase and a gaseous phase of the working fluid.

FIG. 2 is a curve diagram showing liquid transport factor of different working fluids at different temperatures. The liquid transport factor is a parameter combined of the latent heat of vaporization, surface tension, liquid density and liquid viscosity. In FIG. 2, the heat transfer ability of water is obviously better than that of the working fluid such as acetone, liquid ammonia, methanol, ethanol and so on at an operation temperature (30 to 100° C.) of a common electronic device.

A dense alumina layer with a steady chemical property may be formed on a surface of the aluminum vapor chamber and coefficients of thermal expansion (CTE) of the aluminum plate and the alumina layer are 23.1×10⁻⁶/K and 7×10⁻⁶/K, respectively, therefore, slight cracks may be formed between the aluminum plate and the alumina layer after a plurality of times of the cooling and heating cycles due to the large difference between the two coefficients of thermal expansion. If the water is used as the working fluid in the aluminum vapor chamber, the water may permeate through the cracks and contact aluminum further to have a chemical reaction with the aluminum, thereby causing failure of the vapor chamber. Therefore, the conventional aluminum vapor chamber just can use the working fluid with the poorer heat transfer ability and incapable of reacting with the aluminum, which results in the poorer heat dissipation effect.

Furthermore, the surface of the aluminum vapor chamber fails to be connected with other powder metal since the dense alumina layer with a steady chemical property is formed on the surface of the aluminum vapor chamber, or the aluminum vapor chamber is not treated via a surface metalizing process (such as nickel plating). On the other hand, since a melting point of the alumina is 2072° C. and a sintering temperature is 1700° C., and the melting point of the alumina and the sintering temperature are much higher than a melting point of the aluminum which is 660° C., the wick structure in the aluminum vapor chamber cannot be directly manufactured in a powder sintering mode, which causes that only meshed or groove-type wick structure can be used in the conventional aluminum vapor chamber. However, heat flux of the groove-type wick structure is quite small and the heat flux can only reach 33 W/cm² so that the groove-type wick structure is not fit for heat dissipation of a high power transistor. As far as the meshed wick structure is considered, the attaching condition between the wick structure and the plate of the vapor chamber is not better, which may cause great increase of thermal resistance of the vapor chamber, further to seriously affect the heat dissipation of the vapor chamber.

### BRIEF SUMMARY OF THE INVENTION

This invention provides a vapor chamber and a manufacturing method thereof to improve the prior art.

According to one embodiment of the invention, a vapor chamber is provided. In the embodiment, the vapor chamber includes a casing, a working fluid, a waterproof layer, and a wick structure layer. The working fluid is filled into the casing. The waterproof layer is formed on inner walls of the casing. The wick structure layer is formed on the waterproof layer.

According to another embodiment of the invention, a manufacturing method for a vapor chamber is provided. First, a casing is provided. Then, a waterproof layer is formed on inner walls of the casing. Then, a wick structure layer is formed on the waterproof layer. Afterwards, a working fluid is filled into the casing. Finally, the casing is sealed.

Compared with the prior art, the present invention keeps advantages of the conventional aluminum vapor chamber, such as having lower cost and light weight; and further, the present invention can use water with the better heat transfer ability at a normal temperature as the working fluid for cooling through forming the waterproof layer and the powder porous wick structure layer on the inner walls of the aluminum vapor chamber in order via thermal spray technology, thereby greatly improving the heat dissipation effect of the aluminum vapor chamber. In addition, since the material of the wick structure layer is chemically compatible with water and is incapable of reacting with the water, the surface of the wick structure layer does not need to be plated with a waterproof layer additionally, which can reduce the whole thickness and save material cost.

These and other features, aspects, and advantages of the present invention will become better understood with regard to the following description, appended claims, and accompanying drawings.

### BRIEF DESCRIPTION OF THE DRAWINGS

FIG. 1A is an exploded diagram showing a conventional aluminum vapor chamber;

FIG. 1B is a sectional diagram showing a conventional aluminum vapor chamber;

FIG. 2 is a curve diagram showing liquid transport factor corresponding to different working fluids at different temperatures;

FIG. 3 is an exploded diagram showing a vapor chamber according to one embodiment of the invention;

FIG. 4 is an appearance diagram showing a base in FIG. 3;

FIG. 5 is a sectional diagram showing the vapor chamber in FIG. 3;

FIG. 6 is an enlarged view showing an area R in FIG. 5; and

FIG. 7 is a flowchart showing a manufacturing method for a vapor chamber according to another embodiment of the invention.

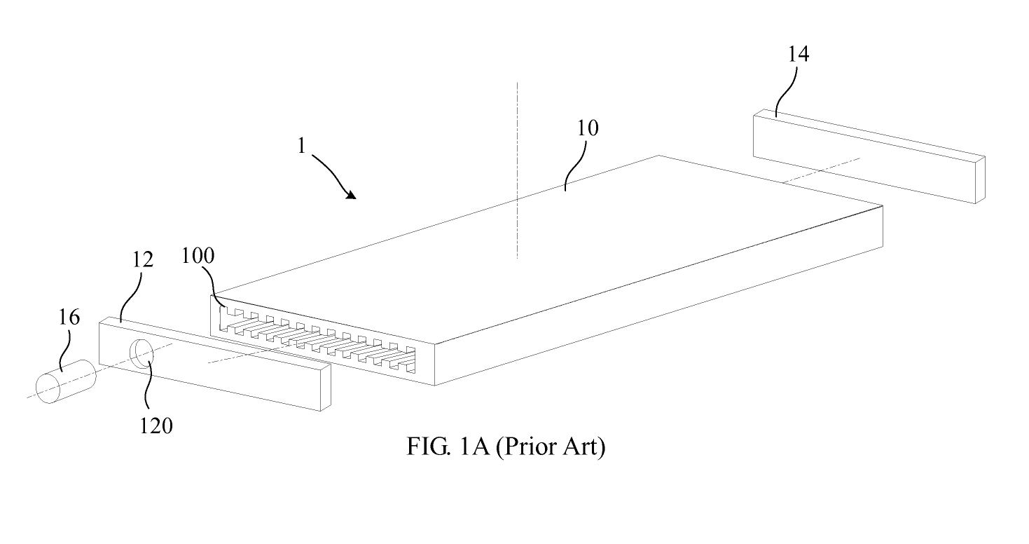

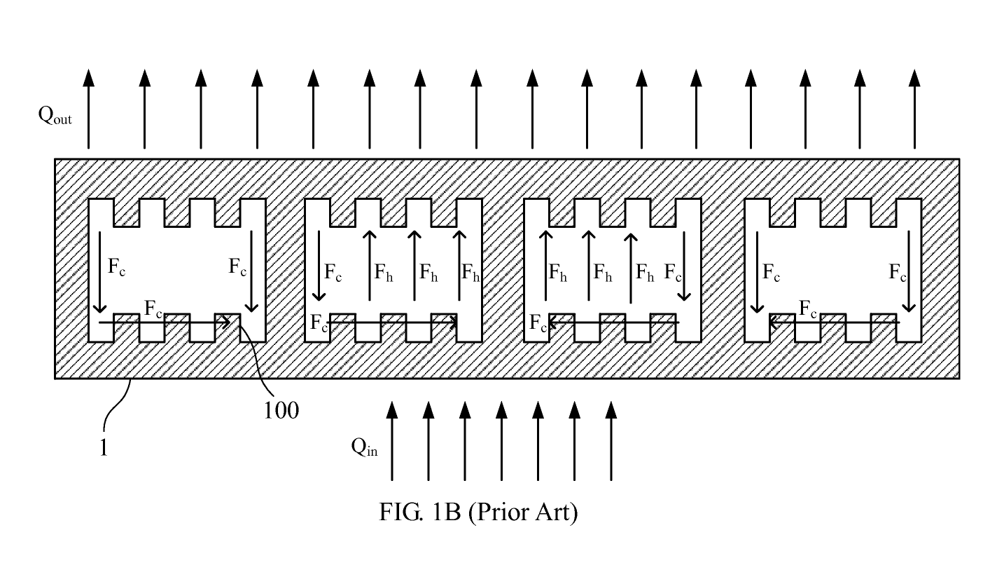

### DETAILED DESCRIPTION OF THE INVENTION

According to one embodiment of this invention, a vapor chamber is provided. In a practical application, the vapor chamber is used for cooling an electronic device, and a casing of the vapor chamber is made of a material which is chemically incompatible with water. The material may be metal such as aluminum, iron, stainless steel and so on. In addition, the water is used as a working fluid in the vapor chamber for cooling, thereby improving heat transfer ability and reducing thermal resistance thereof.

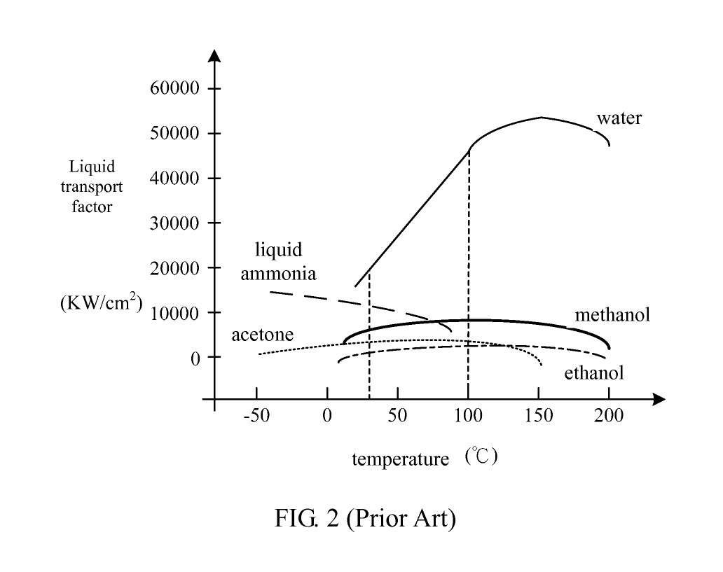

FIG. 3 is an exploded diagram showing a vapor chamber according to one embodiment of the invention. In FIG. 3, a vapor chamber 2 includes a top cover 20, a base 21, a first side plate 22, a second side plate 24, a filling pipe 26, and a wick structure layer 28. Practically, the number of the plates forming a casing of the vapor chamber 2 is not limited to four (the top cover 20, the base 21, the first side plate 22, and the second side plate 24) in the embodiment, and it can be determined according to actual needs. A filling hole 220 is disposed at the first side plate 22 for filling water into the vapor chamber 2 via the filling pipe 26. When the top cover 20, the base 21, the first side plate 22, the second side plate 24, and the filling pipe 26 are assembled to form the casing of the vapor chamber 2, a containing space is formed in the casing of the vapor chamber 2 to contain the water used as a working fluid. Therefore, the wick structure layer 28 (and the waterproof layer below the wick structure layer) covers all inner walls of the containing space which may contact the water. That is, the wick structure layer 28 covers inner surfaces of the top cover 20, the base 21, the first side plate 22, and the second side plate 24 as shown in FIG. 3.

In the embodiment, the base 21 is manufactured via aluminum extrusion or die-casting molding, while the top cover 20, the first side plate 22, and the second side plate 24 are manufactured via cold forging and stamping molding. In practical, the manufacturing method for the top cover 20, the first side plate 22, and the second side plate 24 is not limited to the above molding methods such as aluminum extrusion molding, die-casting molding, or cold forging and stamping molding and so on, and the materials of the base, the top cover, and the two side plates are also not limited to aluminium such as pure aluminum or aluminium alloyes and so on, which can be determined according to actual needs.

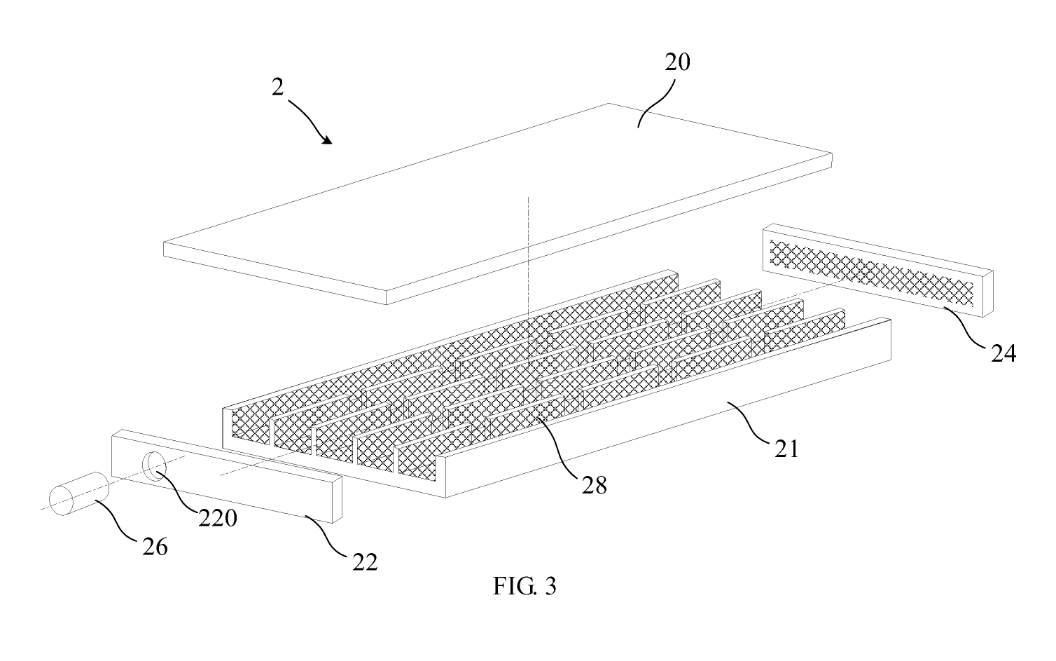

FIG. 4 is an appearance diagram independently showing the base 21 of the vapor chamber 2. In FIG. 3 and FIG. 4, a plurality of supporting plates 210, such as rib plates as shown in FIG. 4, are disposed at the base 21. The supporting plates 210 is against between the base 21 and the top cover 20 to reinforce the structure of the whole vapor chamber 2. The number and the position of the supporting plates 210 can be determined according to actual needs and are not limited thereto.

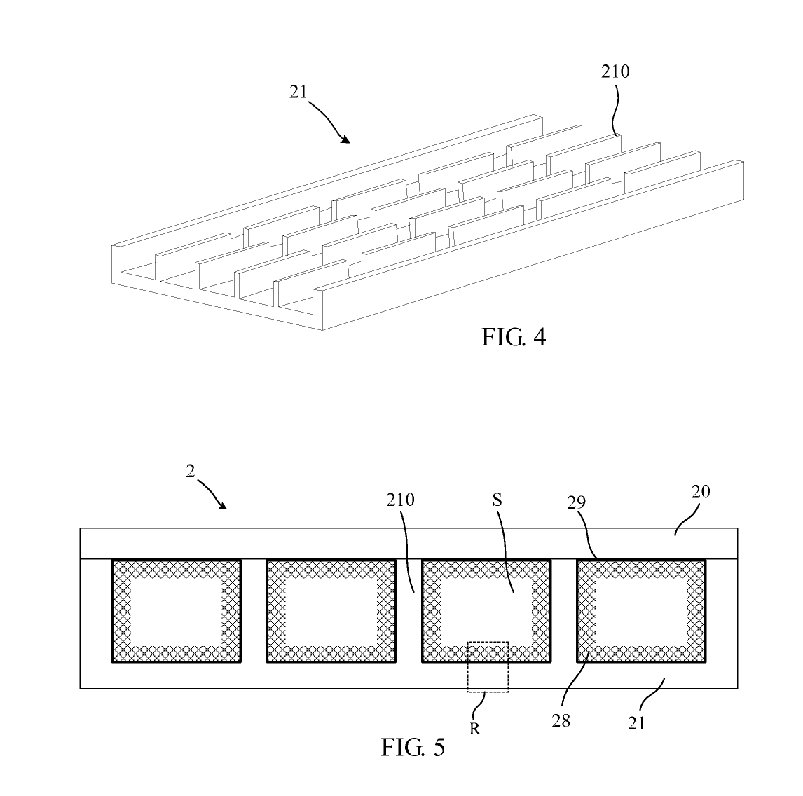

FIG. 5 is a sectional diagram showing the vapor chamber 2 in FIG. 3. That is, FIG. 5 is a sectional diagram showing the vapor chamber 2 which is completely assembled. In FIG. 5, the inner walls (i.e. the inner surfaces of the top cover 20, the base 21, and the standing plate 210) of a containing space S of the casing of the vapor chamber 2 are all covered with the waterproof layer 29, and the waterproof layer 29 is also covered with the wick structure layer 28 thereon. In the embodiment, the waterproof layer 29 and the wick structure layer 28 are formed via thermal spray molding in order on the inner surfaces of the top cover 20, the base 21, the first side plate 22, and the second side plate 24 which may contact the water. However, the invention is not limited thereto.

In a practical application, the thermal spray molding may be thermal spray molding in different forms such as plasma spray, arc spray, flame spray, or high velocity oxy-fuel spray and so on, and the thermal spray molding can be performed at a high temperature or a low temperature. However, the invention is not limited thereto. The spray material used in the thermal spray molding may be metal or ceramic which is chemically compatible with and is incapable of reacting with the working fluid in the vapor chamber 2. In the embodiment, since the water is used as the working fluid in the vapor chamber 2, the spray material chemically compatible with the water and incapable of reacting with the water, such as copper, brass, nickel, or titanium and so on, is used in the thermal spray molding process for forming the waterproof layer 29 and the wick structure layer 28. However, the invention is not limited thereto.

In the embodiment, after the spray material forming the waterproof layer 29 is melted into liquid first, powder particles with a diameter of 5 to 200 nm are blown out by high pressure gas and are speedily injected and stacked on the inner surfaces of the top cover 20, the base 21, the first side plate 22, and the second side plate 24 which may contact the water thus to form the waterproof layer 29 with a thickness of 10 to 50 μm. Similarly, after the spray material forming the wick structure layer 28 is melted into liquid first, powder particles with a diameter of 35 to 250 μm are blown out by high pressure gas and are speedily injected and stacked on the surface of the waterproof layer 29 to form the powder porous wick structure layer 28 with a thickness of 0.1 to 0.8 mm.

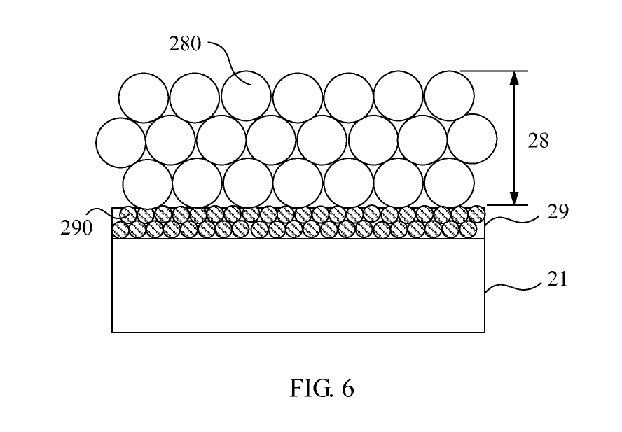

FIG. 6 is an enlarged view showing an area R in FIG. 5. In FIG. 6, the thickness of the waterproof layer 29 formed on the base 21 is much less than that of the wick structure layer 28 formed on the waterproof layer 29, and the size of the powder particles 290 forming the waterproof layer 29 is much less than that of the powder particles 280 forming the wick structure layer 28. Furthermore, since porosity of the wick structure layer 28 is between 30% and 70%, and the porosity of the wick structure layer 28 is much greater than that of the waterproof layer 29 which is less than or equal to 2%, the wick structure layer 28 is porous and the waterproof layer 29 can effectively prevent the water from contacting and reacting with the aluminum base 21 below the waterproof layer 29.

In a practical application, the spray materials forming the waterproof layer 29 and the wick structure layer 28 may be the same (for example, both of them may be copper) or may be different (for example, they may be brass and nickel, respectively). The invention is not limited thereto. However, the same material is preferred.

According to another embodiment of the invention, a manufacturing method for a vapor chamber is provided. In a practical application, the vapor chamber manufactured by the manufacturing method for a vapor chamber is used for cooling an electronic device, and a casing of the vapor chamber is made of a material chemically incompatible with water, such as iron, stainless steel and so on. That is, the material may react with the water thus to cause failure or deterioration. In addition, the water is used as a working fluid for cooling the vapor chamber, thereby improving the heat transfer ability and reducing thermal resistance.

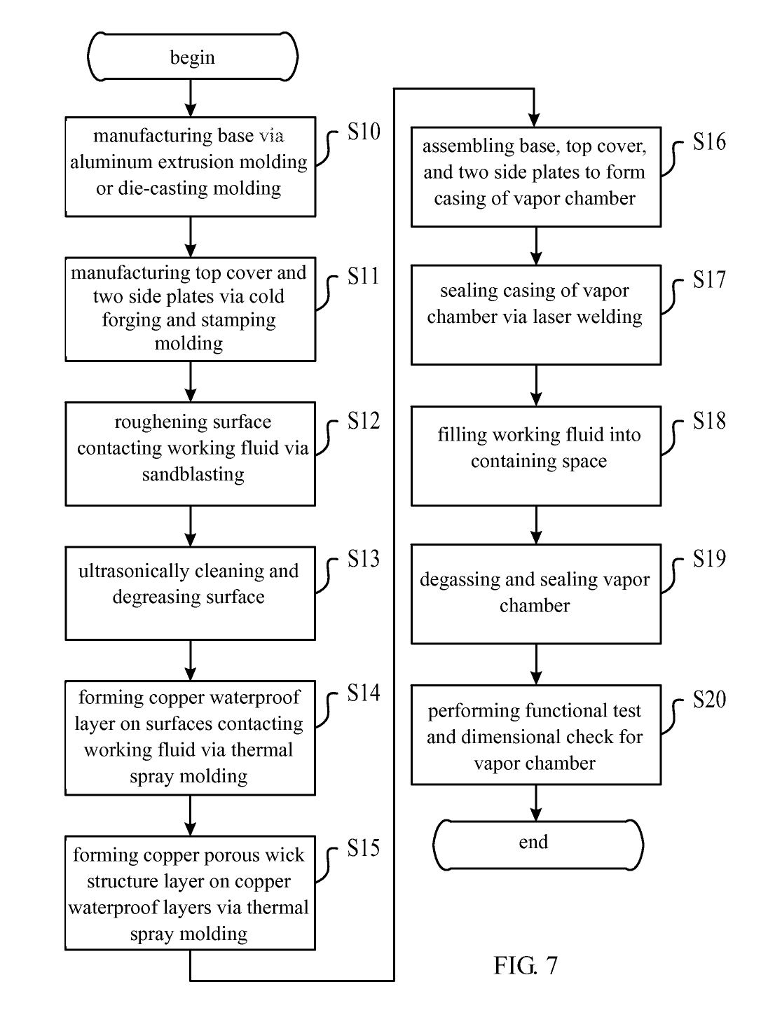

FIG. 7 is a flowchart showing a manufacturing method for a vapor chamber according to another embodiment of the invention. In FIG. 7, steps S10 and S11 are performed, respectively, to manufacture a base via aluminum extrusion molding or die-casting molding and to manufacture a top cover and two side plates via cold forging and stamping molding. In the embodiment, the base, the top cover, and the two side plates are made of aluminum such as conventional pure aluminum or aluminium alloys and so on.

In fact, the manufacturing methods for the base, the top cover, and the two side plates are not limited to the above molding methods such as aluminum extrusion molding, die-casting molding, or cold forging and stamping molding and so on, and the materials of the base, the top cover, and the two side plates are also not limited to aluminium such as pure aluminum, aluminium alloys and so on, which can be determined according to actual needs. In addition, a plurality of supporting plates can be disposed at the base. When the base, the top cover, a first side plate, and a second side plate are assembled, the supporting plates can be against between the base and the top cover thus to divide the interior of a casing of the vapor chamber into a plurality of containing spaces and to reinforce the structure supporting the vapor chamber. The number and the position of the supporting plates can be determined according to actual needs.

Then, step S12 is performed to roughen a surface contacting a working fluid (i.e. water) via sandblasting. The purpose of performing the step S12 in the manufacturing method for a vapor chamber is that all surfaces of the base, the top cover, and the two side plates which may contact the working fluid are processed via the sandblasting or other roughening processes in advance thus to increase the roughness of the surfaces to allow adhesion of the spray material sprayed on the surfaces to be stronger. Then, step S13 is preformed to ultrasonically clean and degrease the surfaces for being beneficial to the following spray process.

Afterwards, step S14 is performed to form a copper waterproof layer on the surfaces contacting the working fluid via thermal spray molding. In a practical application, the thermal spray molding may be thermal spray molding in different forms such as plasma spray, arc spray, flame spray, or high velocity oxy-fuel spray and so on, and the thermal spray molding can be performed at a high temperature or a low temperature. However, the invention is not limited thereto.

In step S14, the spray material used in the thermal spray molding may be metal or ceramic which is chemically compatible with the working fluid and is incapable of reacting with the working fluid in the vapor chamber. Since the water is used as the working fluid of the vapor chamber in the embodiment of the invention, a material chemically compatible with the water and incapable of reacting with the water is used in the thermal spray molding. For example, a material such as copper, brass, nickel, or titanium and so on may be used as the spray material of the waterproof layer. In step S14, after the spray material is melted into liquid first, powder particles with a diameter of 5 to 200 nm are blown out by high pressure gas and are speedily injected and stacked on the surfaces contacting the working fluid to form the waterproof layer with a thickness of 10 to 50 μm.

Afterwards, step S15 is performed to form a copper porous wick structure layer on the copper waterproof layers via the thermal spray molding. Similarly to step S14, the thermal spray molding used in step S15 can also be thermal spray molding in different forms such as plasma spray, arc spray, flame spray, or high velocity oxy-fuel spray and so on, and the thermal spray molding can be performed at a high temperature or a low temperature. However, the invention is not limited thereto. In addition, in the thermal spray molding in step S15, a material which is chemically compatible with and is incapable of reacting with the water, such as copper, brass, nickel, titanium and so on, is used as the spray material of the wick structure layer.

The spray materials used in step S14 and step S15 may be the same material (for example, the spray material forming the waterproof layer and the spray material forming the wick structure layer may be copper) or may be different materials (for example, the spray material forming the waterproof layer is titanium, and the spray material forming the wick structure layer is copper). The invention is not limited thereto. However, the same material is preferred.

In step S15, after the spray material is melted into liquid first, powder particles with a diameter of 35 to 250 μm is blown out by high pressure gas and are speedily injected and stacked on the surfaces of the waterproof layers to form the powder porous wick structure layer with a thickness of 0.1 to 0.8 mm. By comparing step S14 with step S15, although the waterproof layer and the wick structure layer are both formed via the thermal spray molding, the wick structure layer is greatly thicker than the waterproof layer, and the size of the powder particles stacked to form the wick structure layer is also much greater than that of the powder particles stacked to form the waterproof layer. Further, the porosity of the wick structure layer which is between 30% and 70% is also much greater than that of the waterproof layer which is less than or equal to 2%. Therefore, the wick structure layer is porous and the waterproof layer can effectively prevent the water from contacting and reacting with the aluminum vapor chamber below the waterproof layer.

Then, step S16 and step S17 are performed in order. After the base, the top cover, and the two side plates are assembled to form the casing of the vapor chamber, the casing of the vapor chamber is sealed via a method such as laser welding or plasma arc welding and so on. Since the casing of the vapor chamber forms a sealed containing space in the interior, step S18 can be performed to fill the working fluid (i.e. the water) into the containing space. In a practical application, the vapor chamber may further include a filling pipe disposed at one of the side plates for facilitating filling the working fluid. Finally, step S19 and step S20 are preformed in order. After the vapor chamber is degassed via vacuum-pumping, sealed, and a functional test and a dimensional check are performed, the whole flow path of manufacturing the vapor chamber is completed.

To sum up, compared with the prior art, according to the vapor chamber and the manufacturing method thereof in the invention, advantages of the conventional vapor chamber, such as having low cost and light weight, can be kept, and the waterproof layer and the powder porous wick structure layer can be formed on the inner walls of the aluminum vapor chamber in order via thermal spray technology, thus to allow the aluminum vapor chamber to use the water with the better heat transfer ability at a normal temperature as the working fluid for cooling, thereby greatly improving the heat dissipation effect of the aluminum vapor chamber. In addition, since the material of the wick structure layer is chemically compatible with the water and is incapable of reacting with the water, the surface of the wick structure layer does not need to be plated with a waterproof layer additionally, which can reduce the whole thickness and save material cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A vapor chamber comprising:
a casing;
a working fluid filled into the casing;
a waterproof layer formed on inner walls of the casing; and
a wick structure layer formed on the waterproof layer.

2. The vapor chamber according to claim 1, wherein the working fluid is water.

3. The vapor chamber according to claim 2, wherein the waterproof layer and the wick structure layer are made of material incapable of reacting with the water, and the material is selected from a group consisting of copper, brass, nickel, and titanium.

4. The vapor chamber according to claim 1, wherein the wick structure layer is a powder porous wick structure layer.

5. The vapor chamber according to claim 1, wherein the wick structure layer is thicker than the waterproof layer.

6. The vapor chamber according to claim 1, wherein porosity of the waterproof layer is less than or equal to 2%.

7. The vapor chamber according to claim 1, wherein porosity of the wick structure layer is between 30% and 70%.

8. The vapor chamber according to claim 1, wherein the casing includes a base, a top cover, a first side plate, and a second side plate.

9. The vapor chamber according to claim 8, further comprising:
a plurality of supporting plates being against between the base and top cover.

10. The vapor chamber according to claim 9, wherein the waterproof layer and the wick structure layer are disposed at the supporting plates in order.

11. The vapor chamber according to claim 1, wherein the casing is made of metal, and the metal is selected from a group consisting of aluminum, iron, and stainless steel.

12. The vapor chamber according to claim 1, wherein the waterproof layer and the wick structure layer are formed on the inner walls of the casing in order via thermal spray molding.

13. A manufacturing method for a vapor chamber, comprising the following steps of:
providing a casing;
forming a waterproof layer on inner walls of the casing;
forming a wick structure layer on the waterproof layer;
filling a working fluid into the casing; and
sealing the casing.

14. The manufacturing method for a vapor chamber according to claim 13, wherein the casing includes a base, a top cover, a first side plate, and a second side plate.

15. The manufacturing method for a vapor chamber according to claim 14, wherein the waterproof layer and the wick structure layer are formed on the base, the top cover, the first side plate, and the second side plate.

16. The manufacturing method for a vapor chamber according to claim 15, wherein the manufacturing method further comprises the following step of:
assembling the base, the top cover, the first side plate, and the second side plate to form the casing.

17. The manufacturing method for a vapor chamber according to claim 13, wherein the working fluid is water.

18. The manufacturing method for a vapor chamber according to claim 17, wherein the waterproof layer and the wick structure layer are made of material incapable of reacting with the water, respectively, and the material is selected from a group consisting of copper, brass, nickel, and titanium.

19. The manufacturing method for a vapor chamber according to claim 13, wherein the wick structure layer is a powder porous wick structure layer.

20. The manufacturing method for a vapor chamber according to claim 13, wherein the wick structure layer is thicker than the waterproof layer.

21. The manufacturing method for a vapor chamber according to claim 13, wherein porosity of the waterproof layer is less than or equal to 2%.

22. The manufacturing method for a vapor chamber according to claim 13, wherein porosity of the wick structure layer is between 30% and 70%.

23. The manufacturing method for a vapor chamber according to claim 14, wherein the base, the top cover, the first side plate, and the second side plate are made of metal, and the metal is selected from a group consisting of aluminum, iron, and stainless steel.

24. The manufacturing method for a vapor chamber according to claim 13, wherein the step of forming the waterproof layer on the inner walls of the casing is completed via thermal spray molding.

25. The manufacturing method for a vapor chamber according to claim 13, wherein the step of forming the wick structure layer on the waterproof layer is completed via thermal spray molding.
